(19) United States
(12) Patent Application Publication
(10) Pub. No.: US 2013/0080808 A1
(43) Pub. Date: Mar. 28, 2013

(54) BIOMEDICAL DEVICE FOR COMPREHENSIVE AND ADAPTIVE DATA-DRIVEN PATIENT MONITORING

(71) Applicants: Naveen Verma, Princeton, NJ (US); Kyong Ho Lee, Princeton, NJ (US)

(72) Inventors: Naveen Verma, Princeton, NJ (US); Kyong Ho Lee, Princeton, NJ (US)

(73) Assignee: THE TRUSTEES OF PRINCETON UNIVERSITY, Princeton, NJ (US)

(21) Appl. No.: 13/247,126

(22) Filed: Sep. 28, 2011

(51) Int. Cl. G06F 1/32; G06F 15/18

(52) U.S. Cl. 713/322; 706/12

(57) ABSTRACT

A biomedical device for comprehensive and a data-driven patient monitoring is disclosed. The biomedical device includes a receiver to receive sensor data associated with physiological signals and perform feature computations on the sensor data. A control system is included to classify the sensor data using the feature computations to generate medically-relevant decisions and identify relevant data instances, and to automatically select a set of relevant data instances. A base station or programming interface can provide a patient-generic seed model to the biomedical device. The patient-specific seed model is usable by the control system to automatically select a coarse set of relevant data instances that are transmitted to the base station, which in turn analyzes the coarse set of relevant data instances to generate a patient-specific model. The biomedical device receives the patient-specific model, which is usable by the control system to automatically select a refined set of relevant data instances.

### STATEMENT OF GOVERNMENT SUPPORT

This invention was made with government funds under contract number HR0011-07-3-0002 awarded by DARPA. The U.S. Government has rights in this invention.

### FIELD OF THE DISCLOSURE

The present disclosure relates to energy efficient battery-operated or self-powered biomedical devices.

### BACKGROUND

Biomedical sensor nodes transmit and possibly process biomedical data gathered by sensors associated with a patient. Biomedical sensor nodes can have a major impact on healthcare if they are capable of providing clinically relevant inferences that are usable for actionable medical decision support. For the purpose of this disclosure an inference is a process of making conclusions using data that is subject to variation that may be caused by observational errors, physiological variances, hardware-induced variances, and/or environmental variations.

Low-power sensing technologies are currently available for continuously providing electrocardiogram (ECG) signals and electroencephalogram (EEG) signals to low power recording devices. However, such signals are subject to numerous physiologic variances that are relatively difficult to model.

Support Vector Machines (SVMs) are state-of-the-art machine-learning classifiers that analyze signal segments by extracting features and representing these features as vectors. Moreover, SVM algorithms are related to supervised learning methods that are rapidly gaining popularity to analyze data, and in particular, biomedical data recovered from complex signals such as ECG and EEG signals as well as relatively less complex signals generated by blood pressure monitors, accelerometers, pulse-oximeters and the like. A classifier model for such signals is generated using selected feature vectors, called support vectors (SVs).

FIG. 1 is a graph that depicts detector performance of a SVM with regard to specificity shown in dashed line and sensitivity shown in solid line. In this graph, detector performance of the SVM is depicted as percentage versus the number of SVs available to the SVM. Notice that a relatively large number of SVs is needed for a high degree of sensitivity and accuracy.

FIG. 2 is a graph depicting energy profiling that plots energy per feature vector (FV) versus the number of SVs. A feature extraction requires at least 1.56 mJ/FV. Classifier energy usage scales proportionally as the number of SVs increases. An example of scale shown in FIG. 2 depicts a range of about 40× to about 100× for classifier energy usage for a number of SVs equaling 11,000. Thus, in higher-order classifier models, classifier energy dominates over energy usage needed for feature extraction and sensor operation. Data used to construct the graphs of FIG. 1 and FIG. 2 was developed from an ECG-based cardiac arrhythmia detector.

Specialized SVM based biomedical devices have been developed that reduce classification energy usage to a relatively low level using software implemented SVMs. However, such specialized SVM based biomedical devices employ either inflexible SVM algorithms or much lower order models that are insufficient for effectively handling general biomedical signals. Also, while such specialized SVM based biomedical devices can be trained via explicit expert intervention such as through a clinical office visit, they are not flexible enough to efficiently provide clinically relevant inferences needed for remote retraining. As such, existing SVM based biomedical devices are not suitable for comprehensive and adaptive data-driven patient monitoring over a large-scale health care network. For the purpose of this disclosure, a large-scale health care network monitors potentially millions of patients simultaneously. Due to the number of patients involved combined with limited bandwidth and human expert resources, it is not feasible to transmit raw sensor data over a large scale health network for later processing. Therefore, a need remains for a biomedical device that is adaptable to monitor a wide range of biomedical signals while both providing the accuracy of high-order models and using relatively low amounts of classification energy and network resources (bandwidth, personnel, etc.) so that comprehensive and adaptive data-driven patient monitoring over a large-scale health care network is realizable.

### SUMMARY

The present disclosure provides a biomedical device having a processor that enables relatively advanced inference for sensor nodes while using relatively small amounts of energy during classification operations and model customization/adaptation operations. As a result, the biomedical device of the present application is well suited for providing comprehensive and adaptive data-driven patient monitoring. Physiological signals processable by the present biomedical device include but are not limited to electrocardiogram (ECG) signals, electroencephalogram (EEG) signals, electromyogram (EMG) signals, and electrogastrogram (EGG) signals. Such signals have relatively complex correlations with the clinical states of interest. To make clinically relevant inferences from such signals very advanced computational methods for making the relevant inferences is necessary. The computer science community has developed some very sophisticated computational tools from the domain of machine learning that are applicable to computationally making relevant inferences from physically complex signals. However, the computer science community has directed their efforts towards machine learning theoretical constructs as opposed to being concerned with computational energy requirements, network/communication limitations, clinical resource limitations, and constraints of a battery operated biomedical monitoring device.

In general, the biomedical device of the present disclosure includes a receiver to receive sensor data associated with physiological signals and perform feature computations on the sensor data, representing data instances. In at least one embodiment of the present disclosure this is done in a highly programmable way, accommodating a wide range of signals and applications. The biomedical device further includes a control system to classify the sensor data using the feature computations to generate relevant decisions, including automatic selection of a set of relevant data instances. The control system further provides medically-relevant decisions by analyzing received sensor data associated with physiological signals. The medically-relevant decisions are improved through an adaptive process described in greater detail below.

The biomedical device is also adapted to receive a patient-generic seed model that is usable by the control system to automatically select a coarse set of more relevant data instances. A wireless interface included with the biomedical device is adapted to wirelessly transmit the coarse set of more relevant data instances to the base station over a wide area network (WAN). The base station analyzes the coarse set of more relevant data instances to generate a patient-specific model. The biomedical device is further adapted to receive from the base station the patient-specific model that is usable by the control system to automatically select a refined set of more relevant data instances. The wireless interface integrated with the biomedical device is adapted to wirelessly transmit the refined set of more relevant data instances to the base station over the WAN.

One objective of the present disclosure is to break down and reconfigure software components of machine learning tools into hardware blocks that have broad applicability for gathering relevant inferences from a broad range of biomedical signal types. Another objective is to adapt the hardware blocks to consume amounts of energy that are orders of magnitude lower relative to traditional software operations performing equivalent tasks. Yet another objective of at least one embodiment is to integrate the hardware blocks with a programmable processor thereby making up a System-on-Chip (SOC) device that offers a high degree of programmability, for instance, for feature computations. Preferably, the SOC device further includes a radio frequency (RF) transceiver for communicating data and commands to and from the SOC device. In at least one embodiment a Bluetooth transceiver is suitable as the RF transceiver of the SOC. Most modern mobile terminals such as a cellular handset, a personal digital assistant, smart phone, or the like include Bluetooth capability. Therefore, the SOC device combined with a mobile terminal communication link can communicate with a WAN such as a large-scale health network to report reduced patient data sets to a remote clinical workstation, etc.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a graph that depicts detector performance of a support vector machine (SVM) with regard to specificity and sensitivity.

FIG. 2 is a graph depicting energy profiling that plots energy per feature vector (FV) versus the number of SVs.

FIG. 3 is a block diagram that depicts a biomedical device of the present disclosure.

FIG. 4 is a block diagram depicting further details of a SVM accelerator.

FIG. 5 is a graph showing the computational effort in terms of processor clock cycles that are required to compute a diversity metric which is needed to identify relevant data instances for adapting the SVM model.

FIG. 6 is a function and process diagram showing how an adaptive-learning data selection (ALDS) unit shares hardware resources with the SVM accelerator and both performs computations and uses computations from a SVM implemented in hardware for model adaptation.

FIG. 7 is a block diagram of an adaptive detector algorithm that is executed by the biomedical device.

FIG. 8 is a graph illustrating active-learner performance versus a number of data batches for an active learner algorithm of the present disclosure.

FIG. 9 is a graph illustrating random learner performance versus the number of data batches for a random learner of the present disclosure, which in comparison with FIG. 8 illustrates the benefits yielded by the active-learner algorithm.

FIG. 10 is a graph that depicts maximum clock frequency versus supply voltage Vdd (V) for the biomedical device of the present disclosure.

FIG. 11 is a graph that depicts energy per clock cycle in picojoules (PJ) versus supply voltage Vdd(V) for the biomedical device of the present disclosure.

FIG. 12 is a table that lists a system on chip (SOC) summary and an application summary for the biomedical device of the present disclosure.

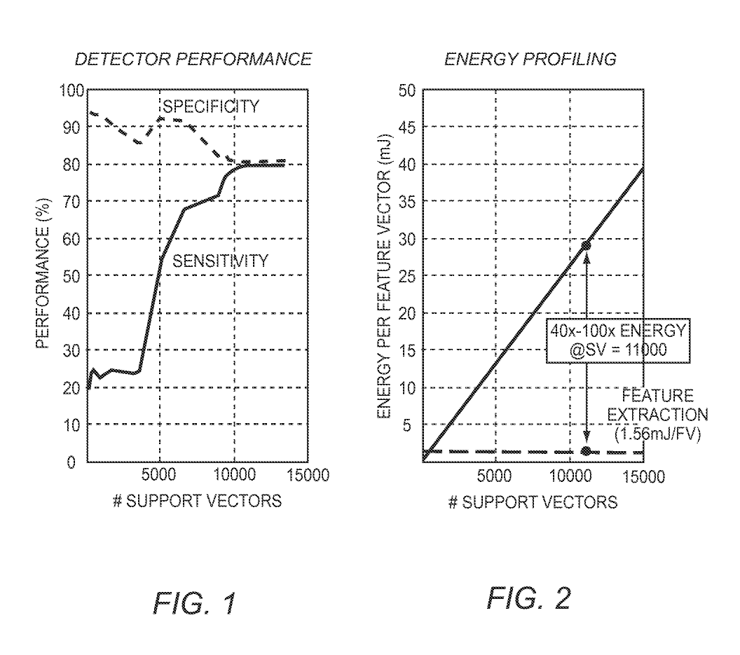

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

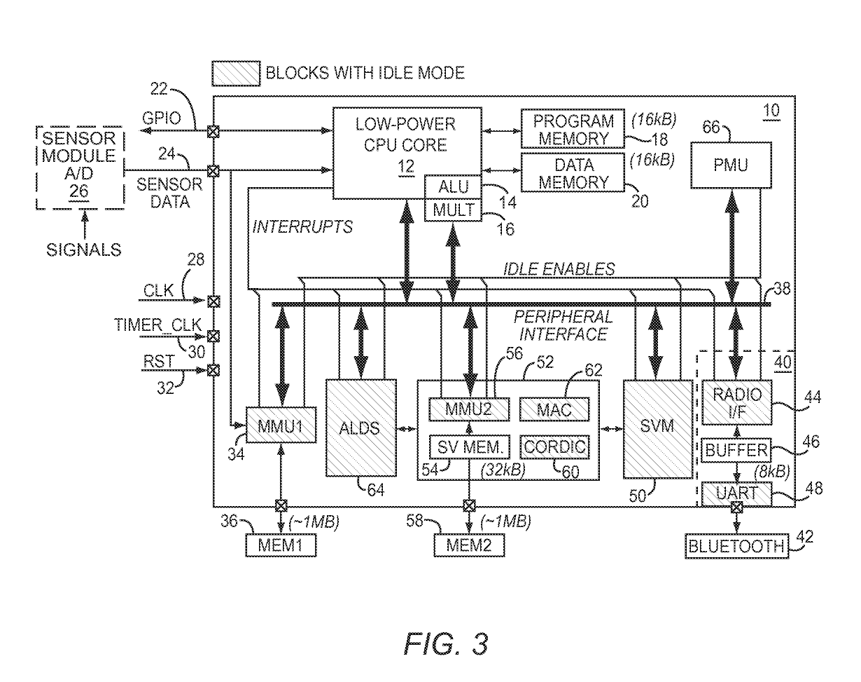

FIG. 3 is a block diagram that depicts a biomedical device 10 of the present disclosure. The biomedical device 10 includes a low-power central processor (CPU) core 12 having an optional arithmetic logic unit (ALU) 14 and an optional multiplier (MULT) 16. A program memory (PMEM) 18 and a data memory (DMEM) 20 are dedicated to the CPU core 12. A general purpose input output bus (GPIO) 22 allows the CPU core 12 to communicate with external devices such as indicator devices (not shown). A sensor data bus 24 in communication with the CPU core 12 is for receiving digital sensor data provided by a sensor module 26 that may include instrumentation amplifiers that amplify biomedical signals for analog-to-digital (A/D) conversion. The sensor module 26 can be external to the biomedical device 10 or the sensor module 26 can be integrated into the biomedical device 10. The sensor module 26 is not limited to sensing complex signals such as ECG and EEG, rather the sensor module 26 may also be adapted to sense relatively less complex signals generated by blood pressure monitors, accelerometers, pulse-oximeters and the like.

A clock (CLK) signal for synchronizing the operations of the biomedical device 10 is provided via a CLK input 28. A timer clock signal for watchdog timing and/or real-time date stamping is provided to the biomedical device 10 via a TIMER_CLK input 30. Moreover, a reset (RST) signal for resetting the biomedical device 10 is provided via a RST input 32.

The biomedical device 10 further includes a first memory management unit (MMU1) 34 for managing memory access to a first external memory (MEM1) 36. The MEM1 36 is usable to store raw sensor data provided by the sensor module 26. Preferably the MEM1 36 can store at least one megabyte of data. The CPU core 12 can access the data stored in the MEM1 36 via a peripheral interface bus 38 and the MMU1 34.

A wireless interface 40 communicates with a wireless device 42 in order to pass data and commands between the biomedical device 10 and a wireless appliance (not shown) such as a smart phone, which in turn passes data and commands between the biomedical device 10 and a large-scale health network via the wireless appliance. The large-scale health network is typically in communication with the Internet which includes cellular gateways such as fourth generation (4G) cellular networks. The wireless interface 40 includes a radio interface (I/F) block 44, a buffer 46, and a universal asynchronous receiver transmitter (UART) 48. It is preferable for the buffer 46 to have at least eight kilobytes of memory.

The wireless interface 40 communicates with the CPU core 12 over the peripheral interface bus 38. The wireless device 42 is shown as an external Bluetooth transceiver that has a relatively short range and energy efficient radio protocol. It is to be understood that the wireless device 42 could be integrated into the biomedical device 10 as a wireless transceiver.

The biomedical device 10 further includes a data-driven classifier such as a support vector machine (SVM) 50 that is implemented in hardware and adapted to automatically classify feature vectors (FVs) generated from raw sensor data collected by sensor module 26. The SVM 50 implements SVM kernels in hardware rather than using traditional software algorithms to increase computational speed. Another highly beneficial result of implementing the SVM 50 rather than implementing a traditional software-based SVM is a relatively large reduction in classification energy usage. For example, the SVM 50 reduces classification energy usage within a range of 40 to 100 times over traditional software-based SVMs when processing relatively large support vector (SV) models having thousands to hundreds of thousands of SVs.

The biomedical device 10 also includes an SVM accelerator 52 that is implemented in hardware to efficiently perform some of the computations required by the SVM 50. The SVM accelerator 52 provides flexible partitioning of an SV memory 54, which enables multiple SVM instances for multi-class detectors, classification boosting, and alternate kernel functions that are usable for model adaptation. A second external memory (MEM2) 58 is usable as extended SV memory if more memory than the memory allotted for SV memory 54 is exceeded. The MEM2 58 is depicted as having about one megabyte of memory, but it is to be understood that larger or smaller quantities of memory are usable as MEM2 58. The SVM accelerator 52 is preferably incorporated in the SVM 50 such that hardware comprising the SVM accelerator 52 is shared with the ALDS unit 64.

The SVM accelerator 52 also includes a second memory management unit (MMU2) 56 for managing data access between the CPU core 12 via the peripheral interface bus 38 and the SV memory 54. The MMU2 56 also manages data access between the MEM2 58 and the CPU core 12 via the peripheral interface bus 38.

The biomedical device 10 is reconfigurable such that conventional SVM computations can be restructured for a broad range of biomedical monitoring applications. The reconfigurability provided by the biomedical device 10 further significantly reduces classification energy usage while processing relatively large SV models.

A coordinate rotation digital computer (CORDIC) 60 integrated in the SVM accelerator 52 is usable to implement a non-linear transformation function (K) that enhances the flexibility of a classifier processed by the SVM 50. The non-linear transformation function K is selectable for energy scalability across applications.

A multiply and accumulate (MAC) 62 is usable to perform in-line scaling to apply SVM model parameters. The MAC 62 also performs configurable shifting to truncate summations performed over various model sizes.

Patient-specific data-driven modeling implemented by the biomedical device 10 uses physiological signals from a particular patient to form customized SV models. As a result, the biomedical device 10 significantly improves accuracy across a broad range of clinical applications that rely on analyzing complex signals such as electrocardiogram (ECG) signals and electroencephalogram (EEG) signals.

An adaptive learning data selection (ALDS) unit 64 that enables automated learning is integrated with the biomedical device 10 for selecting a relatively highly reduced set of FVs that contain data that is automatically prescreened to yield medically relevant data for a health expert such as a clinician. The automatic prescreening of data via the ALDS unit 64 reduces the raw sensor data by potentially a factor of several thousand. As a result, only a relatively small fraction of bandwidth is needed to transmit the highly reduced data set via the wireless device 42 to a wireless appliance (not shown), which in turn makes the reduced data set available to authorized personnel over a large-scale health network. Also, the automatic prescreening of data via the ALDS unit 64 significantly reduces burdens placed on clinicians that receive the data in that they will not have to search through a raw data set for significant medically relevant features because the automatic prescreening of the data will have already located the most significant relevant features. The ALDS unit 64 is implemented in hardware rather than software to increase computational speed, increase energy efficiency, and alleviate computational burden from the CPU. Moreover, it is preferred that the CPU core 12, the SVM 50, the ALDS unit 64, and the SVM accelerator 52 are integrated to form a system-on-chip (SOC) device.

Preferably, a power management unit (PMU) 66 is integrated into the biomedical device 10 for providing idle-mode clock-gating and/or power-gating control of the MMU1 34, the radio I/F 44, the UART 48, the SVM 50, the MMU2 56, the CORDIC 60, the MAC 62, and the ALDS unit 64. The idle-mode control used for the biomedical device 10 provides idle synchronization for the blocks having an idle mode. In this way, energy usage is minimized when no hardware implemented processing is occurring.

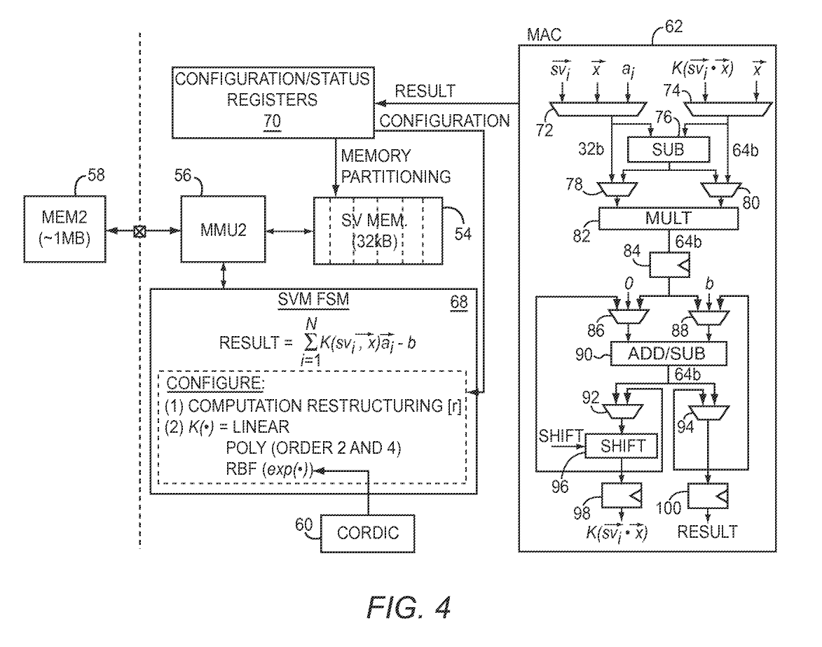

FIG. 4 is a block diagram depicting further details of the SVM accelerator 52. In particular, the SVM accelerator 52 supports multiple programmable SV models, configurable computation restructuring, and selectable transformation kernel functions. For example, the SVM accelerator 52 includes a SVM finite state machine (FSM) 68 that implements computation restructuring along with selection of a transform function K. The transform function K can be a linear function, a polynomial function of order two and four, or a radial basis function (RBF) that involves an exponential engine. The CORDIC 60 can be called upon to perform computations for the RBF. The operation of the SVM FSM 68 is configured by configuration/status registers 70. The SVM FSM 68 controls the MAC 62, which is adapted to compute a result based upon the control provided by the configurable SVM FSM 68.

The MAC 62 can employ various embodiments of logic structures to support computations for the SVM 50 and the ALDS unit 64. In the following exemplary embodiment, the hardware of the MAC 62 is made up of a first operand multiplexer 72 and a second operand multiplexer 74. A subtract (SUB) register 76 receives output from the first operand multiplexer 72 and the second operand multiplexer 74. A third operand multiplexer 78 receives output from the first operand multiplexer 72 and the SUB register 76 while a fourth operand multiplexer 80 receives output from the second operand multiplexer 74 and the SUB register 76. Both the first operand multiplexer 72 and the second operand multiplexer 74 are preferably thirty-two bits (32 b) wide.

A multiply (MULT) register 82 receives outputs from both the third operand multiplexer 78 and the fourth operand multiplexer 80. The MULT register 82 is preferably sixty-four bits (64 b) wide.

A first results register 84 receives output from the MULT register 82. A fifth operand multiplexer 86 and a sixth operand multiplexer 88 receive outputs from the first results register 84. The fifth operand multiplexer 86 and the sixth operand multiplexer 88 also receive inputs of constants that together with the contents of the first results register 84 are processed by an add/subtract (ADD/SUB) register 90.

A seventh operand multiplexer 92 and an eighth operand multiplexer 94 receive the processed contents of the ADD/SUB register 90. A SHIFT register 96 receives output from the seventh operand multiplexer 92 and is responsive to a shift signal. A second results register 98 receives the output of the SHIFT register 96 as a SV dot product.

A final results register 100 receives output from the eighth operand multiplexer 94 and stores the output as final results of the MAC 62. While the MULT register 82 and the ADD/SUB register 90 in the particular embodiment shown in FIG. 4 are both 64 b wide, larger or smaller numbers of bits are feasible. While the SVM 50 and the ALDS 64 unit are preferably implemented as hardware blocks as discussed above to provide energy efficiency gains, functional equivalents to the SVM 50 and ALDS 64 unit can be implemented with software. However, a software implementation equivalent to SVM 50 and ALDS 64 unit will significantly reduce the energy efficiency of the biomedical device 10, thereby limiting battery life.

In operation, the ALDS unit 64 (FIG. 3) controls the SVM 50 (FIG. 3) and performs computations in cooperation with the SVM 50 to classify sensor data associated with physiological signals by using feature computations to generate decisions and also to identify relevant data instances that are processable by the ALDS unit 64 to automatically select a set of relevant data instances. The ALDS unit 64 and the SVM 50 also work in combination to provide medically-relevant decisions by analyzing sensor data associated with physiological signals. The medically-relevant decisions are improved through an adaptive process. For example, the ALDS unit 64 enables active learning that automatically selects a highly reduced set of medically-relevant data instances to communicate to human experts such as clinicians. Transmitting the highly reduced set of medically relevant data instances in batches amortizes communication overheads on the biomedical device 10 (FIG. 3). Tests of the biomedical device 10 shows that model convergence improves significantly over supervised learning techniques that do not perform the proposed computations to select data instances.

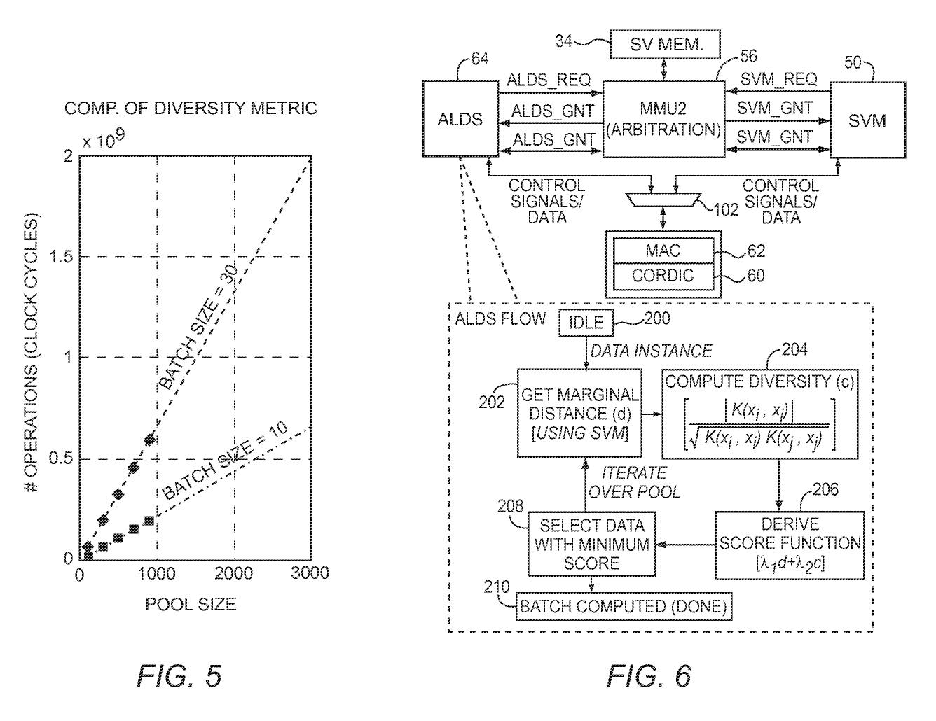

FIG. 5 is a graph showing the computational effort required to compute the diversity metric for two different cases of the number of instances selected. As shown in FIG. 5, a computation of diversity metrics requires a relatively large number of digital operations. Advantageously, the ALDS unit 64 (FIG. 3) allows the computation of diversity metric to be implemented in hardware as a background process.

FIG. 6 is a function and process diagram showing how the ALDS unit 64 shares hardware resources with the SVM accelerator 52 and uses computations from the SVM 50 for model adaptation. However, model adaptation can occur slowly, thus the MMU2 56 works as arbiter to enforce priority for real-time SVM computations. For example, the MMU2 56 receives ALDS requests (ALDS_REQ) and ALDS grants (ALDS_GNT) as well as SVM requests (SVM_REQ) and SVM grants (SVM_GNT). Moreover, a multiplexer 102 passes control signals and data from both the SVM 50 and the ALDS unit 64 to and from the CORDIC 60 and the MAC 62. As a result, the CORDIC 60 and the MAC 62 are shared between the SVM 50 and the ALDS unit 64.

A process flow for the ALDS unit 64 begins with an IDLE process that waits for a data instance (step 200). The data instance is used to get a marginal distance (d) via the SVM 50 (step 202). A diversity value (c) is computed via the CORDIC 60 and the MAC 62 (step 204). Once the marginal distance (d) and the diversity value (c) are computed, a score function [λ₁d+λ₂c] is derived (step 206). The values λ₁ and λ₂ are weights that are assigned to the score function [λ₁d+λ₂c] by the ALDS unit 64. The ALDS unit 64 uses the score function [λ₁d+λ₂c] to select data that has a minimum score (step 208). The selection of data with a minimum score continues as the ALDS unit 64 iterates through a pool of SVs until a batch of data is computed (Step 210).

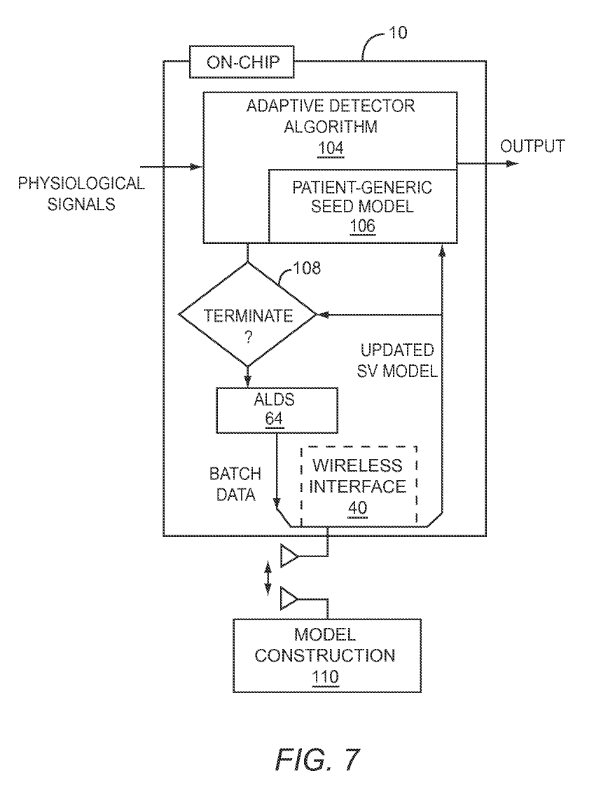

FIG. 7 is a block diagram of an adaptive detector algorithm 104 that is executed by the biomedical device 10 (FIG. 3). The adaptive detector algorithm 104 initially uses a patient-generic seed model 106 to begin collecting batch data for physiological signals that are received as input by the adaptive detector algorithm 104. When the biomedical device 10 is initially deployed on a patient, a healthcare professional can load the patient-generic seed model 106 into the biomedical device 10 through a wired connection to the UART 48. Further still, the healthcare professional can wirelessly load the patient-generic seed model 106 into the biomedical device 10 either locally or remotely via the wireless interface 40. Feature computation for the physiological signals is performed by the CPU core 12 (FIG. 3) using received sensor data associated with the physiological signals. Data driven classifications are performed by the SVM 50. The physiological signals can be biomedical signals such as EEG spectral energies and EEG waveform morphology.

The ALDS unit 64 performs on-going data batch selection until a terminate block 108 determines that enough batch data has been collected to construct and update a new SV model. The wireless interface 40 transmits data batches and receives updated SV models by communicating with a base station 110 on which model construction is realized.

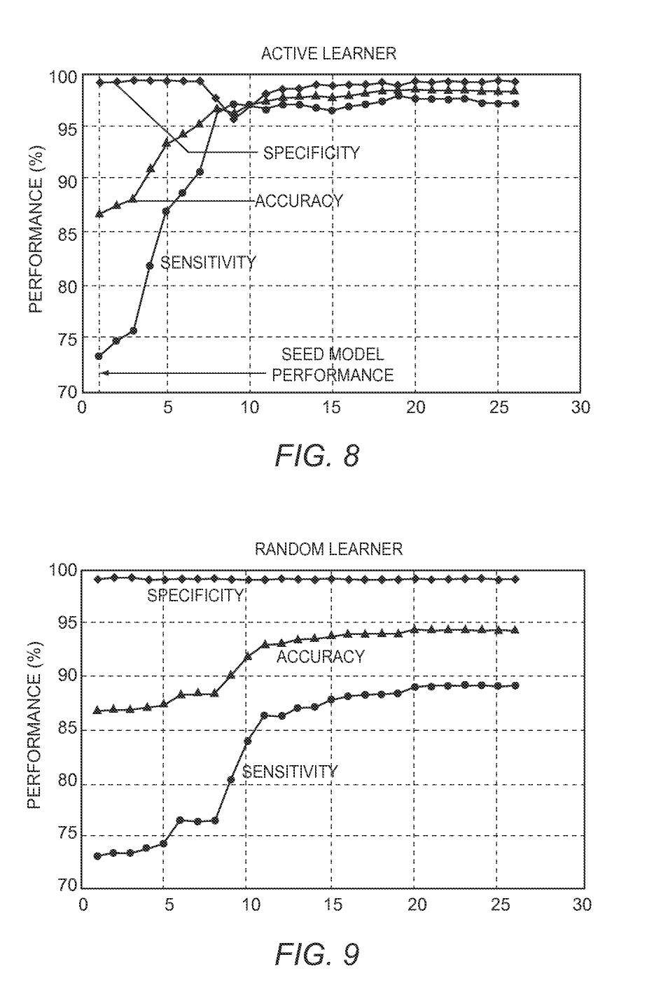

FIG. 8 is a graph for an active-learner plot that illustrates a measured performance of the biomedical device 10 (FIG. 3) while executing the adaptive detector algorithm 104 (FIG. 7). The patient-generic seed model 106 in this exemplary case begins with a sensitivity performance rating of between 70% and 75% and an accuracy of about 86%. However, as the active learner process of the adaptive algorithm collects data batches, the specificity, the sensitivity and the accuracy converges at a performance rating that is greater than 95%.

FIG. 9 is a graph for a random learner in accordance with the present disclosure. As with the previous example, the sensitivity begins with a performance rating of between 70% and 75% and an accuracy of about 86%. However, in this case, the specificity, the sensitivity, and the accuracy do not converge. However, accuracy approaches a 95% performance rating after around twice as many data batches are processed as with the active-learner.

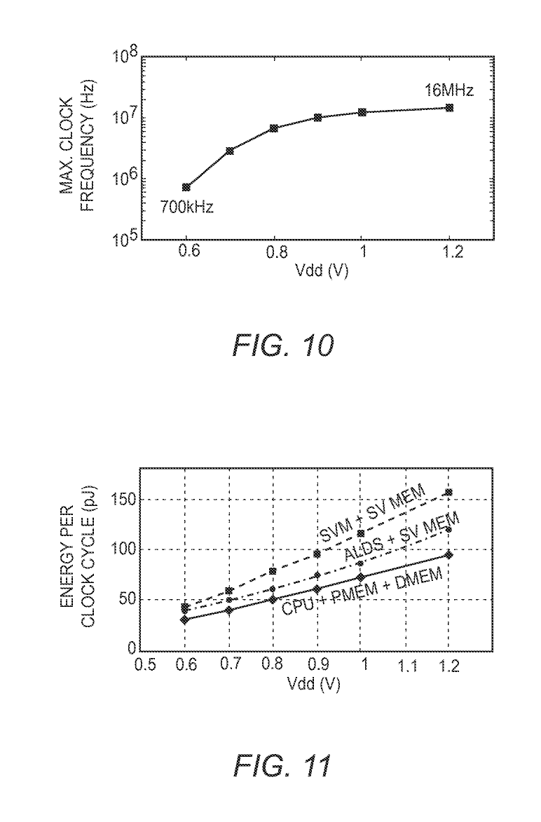

FIG. 10 is a graph that depicts maximum clock frequency versus supply voltage (Vdd) for the biomedical device 10 (FIG. 3). A maximum clock frequency of around 700 kHz is associated with a Vdd of 0.6V, whereas a maximum clock frequency of 16 MHz is associated with a Vdd of 1.2V.

FIG. 11 is a graph depicting energy per clock cycle in picojoules (PJ) versus (Vdd) for the biomedical device 10. Operation of the SVM 50 and the SV memory 54 consume less than 50 pJ of energy per clock cycle with a Vdd of 0.6V. Energy consumption for the SVM 50 and the SV memory 54 increases to slightly over 150 pJ for a Vdd of 1.2V. Operation of the ALDS unit 64 combined with the SV memory 54 consumes slightly less energy per clock cycle than the combined operation of the SVM 50 and the SV memory 54 for a Vdd of 0.6V. However, with Vdd equal to 1.2V, the ALDS unit 64 combined with the SV memory 54 consumes between 100 pJ and 150 pJ per clock cycle. The CPU core 12 combined with the PMEM 18 and the DMEM 20 consumes around 25 pJ per clock cycle at a Vdd of 0.6V and just under 100 pJ per clock cycle at a Vdd of 1.2V.

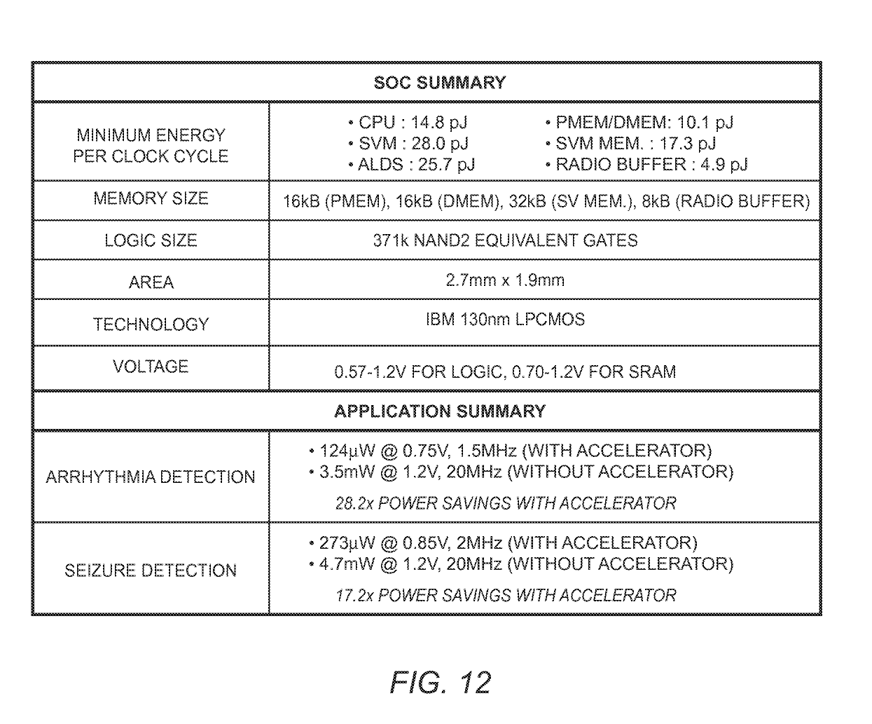

FIG. 12 is a table that includes a system-on-chip (SOC) summary and an exemplary application summary for biomedical device 10. As listed, one embodiment of the hardware implemented blocks such as the SVM 50 and the ALDS unit 64 has a logic size of 371,000 NAND2 (two-input) gates. Moreover, the area for the SOC embodiment of the biomedical device 10 is 2.7 mm×1.9 mm when fabricated using a 130 nm low power (LP) complementary metal oxide semiconductor (CMOS) technology developed by International Business Machines (IBM) Corporation. It is envisioned that the biomedical device 10 can be fabricated on SOCs having smaller areas using more advanced technology. The supply voltage for one embodiment uses a Vdd voltage within the range of 0.57V to 1.2V for logic and a Vdd voltage within a range of 0.7V to 1.2V for static random access memory (SRAM) that is usable for SV memory 54.

The exemplary application summary portion of the table of FIG. 12 shows a power savings of at least twenty-eight times between using an accelerator such as SVM accelerator 52 and not using an accelerator when detecting an arrhythmia. An accelerator such as SVM accelerator 52 provides a seizure detection of at least seventeen times over not using an accelerator.

Those skilled in the art will recognize improvements and modifications to the preferred embodiments of the present disclosure. All such improvements and modifications are considered within the scope of the concepts disclosed herein and the claims that follow.

What is claimed is:

1. A biomedical device comprising:
a receiver to receive sensor data associated with physiological signals and perform feature computations on the sensor data; and
a control system to classify the sensor data using the feature computations to generate relevant data instances, and to automatically select a set of relevant data instances.

2. The biomedical device of claim 1 wherein the control system includes a data-driven classifier that is implemented in hardware.

3. The biomedical device of claim 1 further adapted to receive from a base station a patient-generic seed model that is usable by the control system to automatically select a coarse set of relevant data instances.

4. The biomedical device of claim 3 further including a wireless interface adapted to wirelessly transmit the coarse set of relevant data instances to the base station over a wide area network (WAN).

5. The biomedical device of claim 1 further adapted to receive from a base station a patient-specific model that is usable by the control system to automatically select a refined set of relevant data instances.

6. The biomedical device of claim 5 further including a wireless interface adapted to wirelessly transmit the refined set of relevant data instances to the base station over a WAN.

7. The biomedical device of claim 1 wherein the receiver is a central processing unit (CPU) core and wherein the control system includes a support vector machine (SVM) and an adaptive-learning data selection (ALDS) unit that controls the SVM and performs computations in cooperation with the SVM to classify sensor data using the feature computations to generate decisions and also to identify relevant data instances that are processable by the ALDS unit to automatically select the set of relevant data instances.

8. The biomedical device of claim 7 wherein the SVM and ALDS unit are both implemented in hardware.

9. The biomedical device of claim 8 further including a power management unit adapted to provide idle-mode clock-gating and/or power-gating control of the SVM and the ALDS unit.

10. The biomedical device of claim 7 further adapted to receive from a base station a patient-generic seed model that is usable by the SVM in conjunction with the ALDS unit to automatically select a coarse set of relevant data instances.

11. The biomedical device of claim 7 further adapted to receive from a base station a patient-specific model that is usable by the SVM in conjunction with the ALDS unit to automatically select a refined set of relevant data instances.

12. The biomedical device of claim 11 further including a wireless interface adapted to wirelessly receive the patient-specific model from the base station over a WAN.

13. The biomedical device of claim 7 further including a sensor module adapted to receive physiological signals and perform analog-to-digital (A/D) conversion to provide sensor data to the biomedical device.

14. The biomedical device of claim 7 further including a first memory management unit for managing data transfers between the CPU core and a first external memory that is usable to store raw sensor data.

15. The biomedical device of claim 14 further including a support vector (SV) memory for storing SVs.

16. The biomedical device of claim 15 further including a second memory management unit for managing data transfers between the SV memory and the CPU core and/or managing data transfers between the CPU core and a second external memory that is usable to store SVs in excess of the SVs stored in the SV memory.

17. The biomedical device of claim 7 further including a SVM accelerator adapted to support programmable SV models, and/or configurable computation restructuring, and/or selectable transformation models.

18. The biomedical device of claim 17 wherein the SVM accelerator performs computations for the ALDS unit.

19. The biomedical device of claim 17 wherein the SVM accelerator comprises:
a multiply and accumulate (MAC) adapted to perform in-line scaling to apply SVM model parameters, and/or perform configurable shifting to truncate summations performed over various model sizes; and
a coordinate rotational digital computer (CORDIC) adapted to implement a non-linear transformation function that provides non-linear computations to the SVM.

20. The biomedical device of claim 19 wherein the non-linear transformation function can provide a linear function, a polynomial function or a radial basis function to the SVM.

21. The biomedical device of claim 17 wherein the CPU core, the SVM, the ALDS unit, and the SVM accelerator are integrated to form a system-on-chip (SOC) device.

22. The biomedical device of claim 1 wherein the control system is implemented using software.

23. A base station comprising:
a transmitter to transmit a patient-generic seed model to a biomedical device that generates relevant data instances from sensor data associated with physiological signals, and automatically select a set of relevant data instances;
a receiver to receive the set of relevant data instances; and
a processor to analyze the set of relevant data instances and generate a patient-specific model based upon the set of relevant data instances, wherein the transmitter is configurable to transmit the patient-specific model to the biomedical device.

24. The base station of claim 23 wherein the transmitter and receiver communicate with the biomedical device over a WAN.

25. The base station of claim 23 further including software adapted to analyze the relevant data instances and generate a patient-specific model based upon the relevant data instances.

26. A method comprising:
receiving a data instance associated with a physiological signal;
computing a marginal distance from the data instance;
computing a diversity value;
deriving a score function for the marginal distance and the diversity value;
computing a minimum score via the score function;
selecting the data instance having the minimum score;
accumulating at least one batch of selected data instances to transmit to a base station;
terminating receiving data instances once the at least one batch of selected data instances has been accumulated; and
transmitting the at least one batch of selected data instances to the base station.

27. The method of claim 26 further including receiving a patient-specific model constructed from the at least one batch of selected data instances using the patient-specific model to compute new marginal distances from data instances.

28. The method of claim 27 wherein a sensitivity and accuracy of the patient-specific model converges to a performance rating that is greater than 95%.

29. The method of claim 26 wherein at least one batch of data instances correspond to data instances derived from physiologic signals having spectral energies and waveform morphology.

30. The method of claim 26 wherein the diversity value is computed via a coordinate rotational digital computer (CORDIC) and a multiply and accumulate (MAC).

31. The method of claim 26 wherein the receiving a data instance associated with a physiological signal is achieved via a central processing unit (CPU).

32. The method of claim 26 wherein the computing of the marginal distance from the data instance is achieved via a support vector machine (SVM).

33. The method of claim 32 wherein the SVM is implemented in hardware.

34. The method of claim 26 wherein deriving the score function for the marginal distance and the diversity value is achieved via an adaptive-learning data selection (ALDS) unit.

35. The method of claim 34 wherein computing the minimum score via the score function is achieved using the ALDS unit.

36. The method of claim 34 wherein selecting the data instance having the minimum score is achieved via the ALDS unit.

37. The method of claim 34 wherein accumulating the at least one batch of selected data instances to transmit to a base station is achieved via the ALDS unit.

38. The method of claim 34 wherein the terminating receiving data instances once the at least one batch of selected data instances have been accumulated is achieved by a terminate block.

39. The method of claim 26 wherein the transmitting of the at least one batch of selected data instances to the base station occurs over a wide area network (WAN).

40. The method of claim 34 wherein the ALDS unit is implemented in hardware.
